(19) United States
(12) Patent Application Publication
(10) Pub. No.: US 2018/0096063 A1
(43) Pub. Date: Apr. 5, 2018

(54) AUDIO FILE ACQUISITION AND UPDATE NOTIFICATION SENDING METHOD, DEVICE, AND SYSTEM

(71) Applicant: ALIBABA GROUP HOLDING LIMITED, George Town (KY)

(72) Inventors: Xinchun YANG, Hangzhou (CN); Haitao DU, Hangzhou (CN); Lijuan CHEN, Hangzhou (CN)

(21) Appl. No.: 15/833,963

(22) Filed: Dec. 6, 2017

Related U.S. Application Data
(63) Continuation of application No. PCT/CN2016/085402, filed on Jun. 12, 2016.

(30) Foreign Application Priority Data
Jun. 19, 2015 (CN) 201510346683.0

(51) Int. Cl. G06F 17/30; G06F 3/0481; G06F 3/16

(52) U.S. Cl. CPC G06F 17/30758; G06F 3/167; G06F 3/0481; G06F 17/30368

(57) ABSTRACT

The present application provides audio file acquisition and update notification sending methods, devices, and systems. One audio file acquisition method disclosed herein includes: receiving an audio file update notification by an audio playing device; prompting update by the audio playing device in response to the audio file update notification; receiving an audio file acquisition instruction by the audio playing device; and acquiring an updated audio file by the audio playing device in response to the audio file acquisition instruction. The present application further discloses audio playing devices. Embodiments of the present disclosure can help improve audio file acquisition efficiency and reduce resource consumption.

### CROSS REFERENCE TO RELATED APPLICATION

This application claims priority to International Application No. PCT/CN2016/085402, filed on Jun. 12, 2016, and claims the priority of Chinese Application No. 201510346683.0, filed on Jun. 19, 2015, both of which are incorporated herein by reference in their entireties.

### TECHNICAL FIELD

The present application generally relates to the field of computer technologies, and in particular, to audio file acquisition and update notification sending methods, devices, and systems.

### BACKGROUND ART

At present, a user often uses a terminal such as a mobile phone, a tablet computer, and a personal computer, to acquire an audio file from an audio content source, and send the audio file to an audio playing device. Such audio playing device may be, for example, a device that has a built-in player for decoding and playing an audio file. The device may be provided with a wireless networking module, such as a smart TV or a speaker. An audio content source may be any device that can provide audio files. For example, it may be a server hosting a music website, a server providing serial audiobooks, or a user terminal that can send an audio file to another device.

According to an existing audio file playing process, the audio playing device needs to wait for the user terminal to initiate a connection instruction to connect with the audio playing device. After establishing a connection with the audio playing device, the user terminal actively queries updated audio files from audio content sources. After updates are found through query and updated audio files are acquired from the audio content sources, the user terminal sends the acquired updated audio files to the audio playing device. For the audio playing device, such an audio file acquisition process is relatively tedious. When audio files that can be acquired but have not been acquired by the user terminal (such as related content or updates, referred to as updated audio files hereinafter) frequently appear in the audio content sources, the audio playing device cannot obtain and play the updated audio files in a timely manner.

It should be noted that, the audio files that have not been acquired by the user terminal may be determined according to an audio file acquisition record of the user terminal. The audio file acquisition record of the user terminal may refer to a record file used for recording identifiers of audio files that have been acquired by the user terminal. Audio files that have been acquired by the user terminal may be determined according to the record file. The audio files that have been acquired by the user terminal no longer belong to the scope of updated files, while audio files that have not been acquired by the user terminal may belong to the scope of updated files.

### SUMMARY

Embodiments of the present application provide audio file acquisition and update notification sending methods, devices, and systems.

According to some embodiments of the present disclosure, audio file acquisition methods are provided. One method comprises: receiving an audio file update notification by an audio playing device; prompting an update reminder by the audio playing device in response to the audio file update notification; receiving an audio file acquisition instruction by the audio playing device; and acquiring an updated audio file by the audio playing device in response to the audio file acquisition instruction.

According to some embodiments of the present disclosure, update notification sending methods are provided. One method comprises: determining, by an audio subscription server, whether there is an updated audio file in an audio file series provided by an audio content source; and sending an audio file update notification to the audio playing device when the determination result of the audio subscription server indicates there is an updated audio file. This way, the audio playing device can acquire the updated audio file according to the notification.

According to some embodiments of the present disclosure, audio playing devices are provided. One audio playing device comprises: an update notification receiving unit configured to receive an audio file update notification; a prompting unit configured to prompt an update reminder in response to the audio file update notification; an acquisition instruction receiving unit configured to receive an audio file acquisition instruction; and an updated audio file acquisition unit configured to acquire an updated audio file in response to the audio file acquisition instruction.

According to some embodiments of the present disclosure, update notification sending devices are provided. One update notification sending device comprises: a determination unit configured to determine whether there is an updated audio file in an audio file series provided by an audio content source; and an update notification sending unit configured to send an audio file update notification to an audio playing device when the determination result obtained by the determination unit indicates there is an updated audio file, such that the audio playing device can acquire the updated audio file according to the notification.

According to some embodiments of the present disclosure, audio file acquisition systems are provided. One audio file acquisition system comprises: an audio playing device and an update notification sending device. The update notification sending device is configured to send an audio file update notification to the audio playing device. The audio playing device is configured to receive the audio file update notification; prompt an update reminder in response to the audio file update notification; receive an audio file acquisition instruction; and acquire an updated audio file in response to the audio file acquisition instruction.

According to some embodiments of the present disclosure, an audio playing device may prompt an update reminder, and acquire an updated audio file. According to existing techniques, the user terminal needs to actively query and acquire an updated audio file from an audio content source, and send the updated audio file to the audio playing device. Compared to such a relatively tedious manner, embodiments of the present disclosure can save resources that need to be consumed by the user terminal in actively querying the updated audio file. Further, embodiments of the present disclosure can save the time required for the user terminal to transmit the updated audio file to the audio playing device. Therefore, the acquisition efficiency of updated audio files can be improved, and the audio playing device can acquire the updated audio files in a timely manner.

### BRIEF DESCRIPTION OF THE DRAWINGS

The accompanying drawings illustrated herein are used for providing further illustration of some exemplary embodiments of the present application, and constitute a part of the present application. The descriptions thereof are used for explaining the present application, and do not limit the scope of to the present application.

FIG. 1A is a flowchart of an exemplary audio file acquisition method according to some embodiments of the present application;

FIG. 1B is a schematic interaction diagram illustrating an exemplary information interaction relationship between an audio subscription server and an audio content source according to some embodiments of the present application;

FIG. 2A is a schematic diagram of an implementation scenario according to some embodiments of the present application;

FIG. 2B is a schematic diagram of an exemplary external structure of an audio playing device according to some embodiments the present application;

FIG. 2C is a schematic diagram of an exemplary update prompting and audio playing process performed by an audio playing device according to some embodiments of the present application;

FIG. 2D is a schematic flowchart of an exemplary query process performed by an smart cloud according to some embodiments of the present application;

FIG. 3 is a schematic flowchart of an exemplary method for subscribing to an audio file series according to some embodiments of the present application;

FIG. 4 is a schematic flowchart of an exemplary method for subscribing to an audio file series according to some embodiments of the present application;

FIG. 5 is a schematic flowchart of an exemplary update notification sending method according to some embodiments of the present application;

FIG. 6 is a schematic diagram of an exemplary structure of an audio playing device according to some embodiments of the present application;

FIG. 7 is a schematic diagram of an exemplary structure of an update notification sending device according to some embodiments of the present application; and

FIG. 8 is a schematic diagram of an exemplary structure of an audio file acquisition system according to some embodiments of the present application.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods according to some embodiments of the present disclosure, the scope of which is defined by the appended claims.

It should be appreciated that, the terms such as “first” and “second” in the specification, claims, and the accompanying drawings of the present application are used for differentiating similar objects, and are not necessarily used for describing a specific order or sequence. It should be appreciated that, actual implementation according to the disclosure presented herein may be modified in proper situations, so that embodiments of the present application can be implemented in an order other than those illustrated or described herein. In addition, the terms “include,” “comprise” and variations thereof are intended to cover a non-exclusive inclusion. For example, a process, method, system, product, or device including a series of steps or units is not necessarily limited to the steps or units expressly listed, but can include other steps or units not expressly listed or inherent in such processes, methods, products or devices.

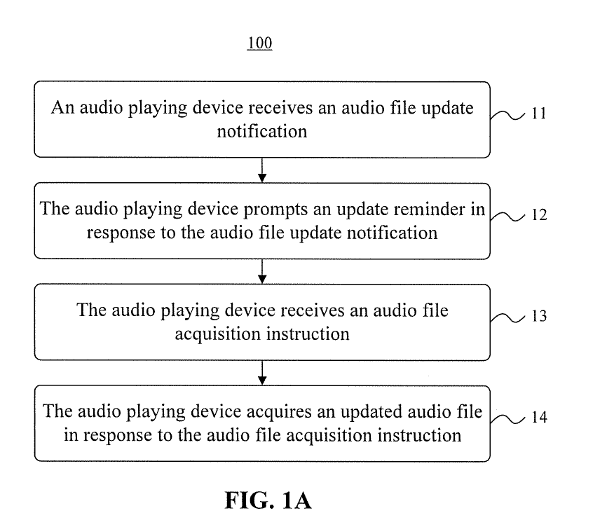

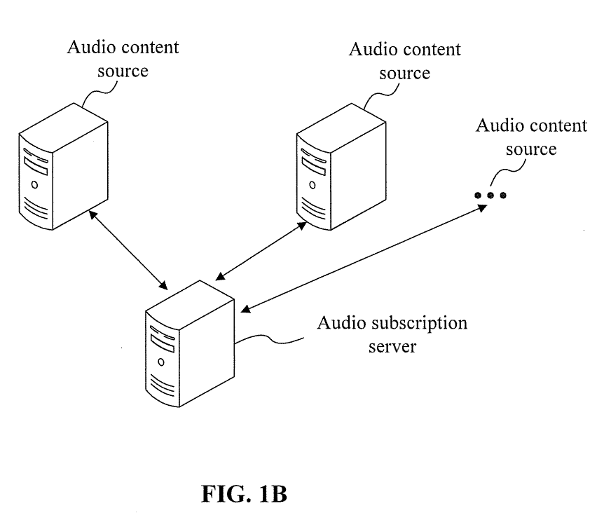

The embodiments of the present disclosure can help solve the problems where an audio playing device cannot acquire updated audio files in a timely manner. According to some embodiment of the present disclosure, audio file acquisition methods are provided. FIG. 1A is a flowchart of an exemplary audio file acquisition method 100 according to some embodiments of the present application. In some embodiments, some steps relating to audio file acquisition method may be performed using a computer system. As shown in FIG. 1A, the audio file acquisition method 100 comprises:

In step 11, an audio file update notification is received by an audio playing device.

In some embodiments of the present application, the audio playing device refers to a device that has a built-in player capable of decoding and playing an audio file, and can be provided with a wireless networking module. For example, the audio playing device may be a device having an audio playing function, such as a smart speaker, a smart TV, or a smart router. With the built-in player, the audio playing device can decode and play an audio file. With the wireless networking module, the audio playing device can establish a wireless connection with another device.

In some embodiments, the wireless networking module may support a Wireless Fidelity (Wi-Fi) protocol. Based on the protocol, the audio playing device may establish a wireless connection with a wireless router, thereby accessing the Internet. In some embodiments, the wireless networking module, may also support a point-to-point Wi-Fi protocol. Based on the protocol, the audio playing device can establish a wireless connection with a device that also supports the point-to-point Wi-Fi protocol. In some embodiments, the wireless networking module, may support a Bluetooth protocol. Based on the protocol, the audio playing device may establish a wireless connection with a device that also supports the Bluetooth protocol. In some embodiments, the wireless networking module may, for example, support a 2G/3G/4G mobile communication protocol, so as to access a mobile communication network based on the mobile communication protocol.

The audio playing device according to some embodiments of the present application may support one of the above communication protocols, and may also support two or more of the above communication protocols. In some embodiments, the audio playing device may be a vehicle-mounted audio playing device.

The audio file update notification received by the audio playing device may be sent by a server, or may be forwarded to the audio playing device by a user terminal after receiving the audio file update notification. The server mentioned herein may be an audio content server serving as an audio content source, or an audio subscription server.

FIG. 1B is a schematic interaction diagram illustrating an exemplary information interaction relationship between an audio subscription server and an audio content source according to some embodiments of the present application. In this example, the audio content sources in FIG. 1B can be servers used for, for example, providing download addresses of audio files to other devices and providing audio files according to download requests. The audio content sources can be, for example, a server of a music website, or a server used for providing audiobooks, or the like.

The audio subscription server in FIG. 1B may be a server used for providing a subscription service of an audio file series. In some embodiments, main functions of the audio subscription server may include: receiving information of audio file series that are sent by different audio content sources, such as information of audio file series that are available for subscription. The audio subscription server can provide such information to the user. After receiving an audio file subscription request sent by the user based on the information of the audio file series, the audio subscription server can establish a mapping relationship between a user identification and information of audio file series that the user requests to subscribe to. The audio subscription server may further receive addresses of updated audio files in the audio file series sent by different audio content sources, and send an audio file update notification to the user. The audio subscription may further perform other related audio file subscription functions, which are not limited by the embodiments presented herein.

It is appreciated that, subscription to an audio file series refers to a user behavior that the user actively requests an audio file series from an audio content source. Based on the subscription, once an updated audio file appears when the audio file series is updated subsequently, the user can obtain the updated audio file. The audio file series can refer to, for example, a file set consisting of audio files. The file set generally includes two or more audio files. These audio files are generally content-related audio files (e.g., audio files of different chapters of a series novel), author-related audio files (e.g., audio files of a series of broadcast programs of a radio host), theme-related audio files (e.g., interview audio files having the theme of “Life of Art”), style-related audio files (e.g., audio files of music of which the style is rock and roll), or the like.

In some embodiments, the audio file update notification can be sent from an audio content source to the audio playing device. Regarding the manner of pushing the audio file update notification by the audio content source to the audio playing device, the audio content source may send the audio file update notification to the audio playing device after it is determined that there is an updated audio file. Specifically, the audio content source may send the audio file update notification to the corresponding audio playing device according to a stored address of the audio playing device, which expects to receive the updated audio file. The address of the audio playing device may be an address of an audio playing device used by a user who subscribes to the audio file. The address may be sent to the audio content source by the audio playing device, or the user terminal. The specific timing for the address may be, for example, in the process of subscribing to an audio file series by the user. In some embodiments, the address may be first sent to the audio subscription server, and then forwarded to the audio content source by the audio subscription server.

In some embodiments, the audio file update notification can be sent from the audio subscription server to the audio playing device. Regarding the manner of pushing the audio file update notification by the audio subscription server to the audio playing device, the audio subscription server may send the audio file update notification to the audio playing device after receiving, from an audio content source, the address of the updated audio file in the audio file series or the audio file update notification. In some embodiments, the audio subscription server may also send the audio file update notification to the corresponding audio playing device according to a stored address of the audio playing device, which expects to receive the updated audio file. The address of the audio playing device may be an address of the audio playing device used by a user who subscribes to the audio file. The address may be sent to the audio subscription server by the audio playing device or the user terminal. The timing for sending the address may be, for example, in the process of subscribing to an audio file series by the user.

The updated audio file may be an audio file in the audio file series subscribed to by the user, or may be an audio file outside the audio file series subscribed to by the user. In some embodiments, the audio content source or the audio subscription server may also send an audio file update notification to an audio playing device used by a user only when an updated audio file is generated in the audio file series subscribed to by the user. For updates generated in audio file series not subscribed to by the user, the audio playing device may not receive notifications.

In step 12, the audio playing device prompts an update reminder in response to the received audio file update notification.

In some embodiments of the present application, after receiving the audio file update notification, the audio playing device may prompt an update reminder, using the notification as a triggering condition. In some embodiments of the present invention, the audio playing device may be provided with a first hardware module configured to present the update reminder, such that the audio playing device can implement the update prompt efficiently.

For example, in some embodiments, the first hardware module may include one of the following hardware structures: an indicator light; a touch screen; a non-touch display screen; and a loudspeaker. Based on the above hardware, the audio playing device may prompt the update reminder in one of the following exemplary manners:

In some embodiments, the audio playing device can perform an operation enabling the indicator light of the audio playing device to be in a pre-set state. The set state here may be, for example, a turn-off state, a turn-on state, a flickering state, sending light rays of a set color, or the like.

In some embodiments, the audio playing device can send a pre-set sound signal. For example, the audio playing device may send the pre-set sound signal via the loudspeaker.

In some embodiments, the audio playing device can display pre-set information on the touch screen or the non-touch display screen of the audio playing device.

The pre-set information may be, for example, pre-set text information such as a message “audio file is updated” or a pre-set picture, or the like.

It should be appreciated that, when an audio file that can be acquired and has not been acquired by the user terminal appears in the audio content source, the audio content source may push the audio file update notification to the user terminal. The user terminal can prompt the update according to the notification. However, there are generally a lot of applications installed in the user terminal, and the update prompt for the updated audio file may be easily mixed in update prompts sent by the applications. Thus, the user may miss or neglect the update prompt for the updated audio file. Therefore, in a scenario where a smart speaker is used to play audio files, the speaker may not be able to acquire the updated audio file in a timely manner.

According to some embodiments of the present application, the audio playing device prompts an update reminder. As there are not a variety of applications installed on the smart speaker, the update reminder prompted by the smart speaker according to the audio file update notification will not be mixed in numerous other update prompts. As a result, the user can be notified, according to the update reminder, that an audio file is updated. Therefore, the smart speaker can acquire the updated audio file in response to an audio file acquisition instruction. This way, the problem that the smart speaker being unable to acquire updated audio files in a timely manner can be effectively avoided.

In step 13, the audio playing device receives an audio file acquisition instruction.

According to some embodiments of the present application, the audio file acquisition instruction may be based on input into the audio playing device by the user, through an information input mechanism of the audio playing device. The information input mechanism mentioned here may be, for example, a second hardware module disposed on the audio playing device and configured to generate the audio file acquisition instruction.

In some embodiments, the second hardware module may include, but not limited to, one of the following hardware structures: an indicator light that can be used as a physical key or button; a touch screen; a physical key; a physical knob; a microphone; a biometric characteristic collection apparatus, and the like.

In some embodiments, the first hardware module and the second hardware module may be integrated into one piece of hardware, for example: the first hardware module and the second hardware module may be integrated into an indicator light of a key (or referred to as a key provided with an indicator light), wherein the key may be a physical key or a physical knob, and the indicator light may be used to indicate the update notification. The user may operate the key to trigger generation of the audio file acquisition instruction.

In some embodiments, the first hardware module and the second hardware module may be integrated into a key provided with a display screen, wherein the display screen may be a touch screen or a non-touch screen, the key may be a physical key or a physical knob, and the display screen may display the update notification. The user may operate the key to trigger generation of the audio file acquisition instruction.

In some embodiments, the first hardware module and the second hardware module may be integrated into a touch screen. The touch screen may display the update notification, and the user may operate the touch screen to trigger generation of the audio file acquisition instruction.

In some embodiments, the first hardware module and the second hardware module may be integrated into a button (such as in the form of a physical key or a physical knob) provided with a loudspeaker. The loudspeaker may broadcast the update notification, and the user may operate the button (e.g., press the physical key or rotate the physical knob) to trigger generation of the audio file acquisition instruction; or the like.

The above examples of integrating the first hardware module and the second hardware module into a same hardware module are only exemplary. Various hardware device multiplexing manners may be used to implement integrating the first hardware module and the second hardware module into the same hardware module, or using the first hardware module and the second hardware module as a hardware module combination.

Alternatively, the first hardware module and the second hardware module may also be different hardware components, that is, used as separate hardware modules. For example, the first hardware module may be a first indicator light, and the second hardware module may be a key provided with a second indicator light.

As an example, in cases where the information input device is the indicator light described above, in addition to having the update prompt function, the indicator light may further be pressed by the user to trigger the interior of the audio playing device to generate an electrical signal. After detecting the electrical signal, it may be determined that the audio file acquisition instruction is received.

In some embodiments, the information input device may be, for example, a remote control device of the audio playing device. The remote control device of the audio playing device may be, but not limited to, a remote control panel, a user terminal that can be used as a remote control panel, and the like.

The audio file acquisition instruction descried above in some embodiments of the present application may be, but not limited to, one of the following signals:

an electrical signal generated when the indicator light on the audio playing device is pressed, wherein the indicator light may be an indicator light configured for update prompt as described above, or may be an indicator light having other functions on the audio playing device;

an electrical signal generated when an physical key on the audio playing device is pressed;

an electrical signal generated when a touch screen on the audio playing device is touched;

an electrical signal generated when a knob on the audio playing device is rotated;

a voice signal input into the audio playing device; and

a specified biometric characteristic input into the audio playing device.

In step 14, the audio playing device acquires an updated audio file in response to the audio file acquisition instruction.

According to some embodiments of the present application, the audio playing device may directly request to acquire the updated audio file from the audio content source, or may request to acquire the updated audio file from the audio subscription server. The updated audio file may be an updated audio file that can be provided by the audio content source, or may be an updated audio file related to an audio file series subscribed to by the user.

In some embodiments, the updated audio file may be an audio file subscribed to by one user for another user. For example, when the birthday of a user A approaches, a user B, as a friend of the user A, may desire to subscribe to a song such as “Happy Birthday to You” for the user A. The user B may operate and trigger his/her user terminal (or audio playing device) to send a subscription request to the audio subscription server (or the audio file source). The subscription request can include an Internet Protocol (IP) address of the user A and a song identification of the song “Happy Birthday to You.” Therefore, the receiving end of the subscription request can be triggered to send the song “Happy Birthday to You” to the IP address of the user A according to the subscription request. It should be appreciated that, the IP address of the user A described here may be an IP address of a user terminal used by the user A, or may be an IP address of an audio playing device used by the user A.

According to some embodiments of the present application, in addition to requesting to acquire the updated audio file from the audio content source or the audio subscription server, the audio playing device may further acquire the updated audio file from the user terminal, or acquire the updated audio file from a local storage space of the audio playing device in response to the audio file acquisition instruction. In some embodiments, an audio file that is stored in the local storage space of the audio playing device may not have been actively acquired by the audio playing device, and therefore can also be considered as an updated audio file. For example, the user terminal may send an audio file (e.g., a file including a speech segment recorded by the user) as an updated audio file via a connection established between the user terminal and the audio playing device. The received updated audio file may be stored in a storage space in the audio playing device, and can serve as an audio file update notification to trigger the audio playing device to prompt the update reminder. Subsequently, the audio playing device may acquire the updated audio file from the storage space in response to an audio file acquisition instruction.

In some embodiments, the audio files are provided by an audio content source. As an example, the acquisition process is described below in detail by using an example in which the audio playing device acquires an updated audio file from the audio content source. The process may include the following sub-steps:

In sub-step (a), the audio playing device sends an address acquisition request to the audio subscription server in response to the audio file acquisition instruction. The address acquisition request may include information of an audio series subscribed to by the user, or may not include such information.

In sub-step (b), the audio playing device receives an acquisition address of the updated audio file sent by the audio subscription server.

In some embodiments, if the address acquisition request does not include the information of the audio series subscribed to by the user, the audio subscription server may send, to the audio playing device, all acquisition addresses of updated audio files. The acquisition addressed can be stored locally, and can be received from each audio content source respectively. If the address acquisition request includes the information of the audio series subscribed to by the user, the audio subscription server can select, from the acquisition addresses of the updated audio files that are stored locally and sent by the audio content sources, an acquisition address of the updated audio file matching the information of the subscribed audio series. The audio subscription server can then send the selected acquisition address to the audio playing device. In some embodiments, the acquisition address of the updated audio file is usually a Uniform Resource Locater (URL) of the audio file.

In sub-step (c), the audio playing device sends an audio file acquisition request to the audio content source according to the acquisition address of the updated audio file.

According to some embodiments of the present application, after the audio playing device receives the acquisition address of the updated audio file, the audio file acquisition request may be sent to the audio content source directly according to the acquisition address of the updated audio file. The user may not need to perform any processing. In some embodiments, the audio playing device may display the information (the information may be, for example, a name or the like) of the updated audio file corresponding to the received acquisition address. The audio playing device may receive an information selection instruction initiated by the user based on the displayed information. According to the acquisition address of the updated audio file corresponding to information selected by the user, the audio playing device may send the audio file acquisition request including the acquisition address corresponding to the selected information to the audio content source.

In sub-step (d), the audio playing device receives the updated audio file sent by the audio content source.

In some embodiments of the present application, to obtain the updated audio file in the audio series subscribed to by the user, the address acquisition request may include one of the following information:

1. an identification of an audio file series to which a subscribed audio file stored locally in the audio playing device belongs;

2. an identification of an audio file series that is acquired from the audio file update notification, wherein updated audio files are found in the audio file series; and

3. a user identification. The server may query a subscription record of the user to obtain a mapping relationship between user identification and identification of the audio file series subscribed to by the user. The user identification can be provided to the server, so that the server may be enabled to know which audio file series are subscribed to by the user, and thereby acquire acquisition addresses of the updated audio files in the series.

In some embodiments, the acquisition address of the updated audio file may be included in the audio file update notification as described above. The process of acquiring, by the audio playing device, the updated audio file from the audio content source in response to the audio file acquisition instruction may include: sending, by the audio playing device, an audio file acquisition request to the audio content source according to the acquisition address of the updated file included in the audio file update notification; and receiving, by the audio playing device, the updated audio file from the audio content source according to the audio file acquisition request. This process may avoid certain information interaction between the audio content source and the audio subscription server, thereby reducing the amount of consumed resources.

It should be appreciated that, the audio playing device can acquire the updated audio file from the audio content source, and the updated audio file described above may refer to an audio file that can be acquired and has not been acquired by the audio playing device. The audio file that has not been acquired by the audio playing device may be determined according to an audio file acquisition record of the audio playing device. The audio file acquisition record of the audio playing device mentioned can be a record file used for recording identifications of audio files that have been acquired by the audio playing device. The audio file acquisition record of the audio playing device may be generated and stored by at least one of the audio content source, the audio subscription server, and the user terminal. Audio files that have been acquired by the audio playing device may be determined according to the audio file acquisition record of the audio playing device. The audio files that have been acquired by the audio playing device may no longer belong to the scope of updated audio files, while audio files that have not been acquired may belong to the scope of updated files.

In view of the above, according to some embodiments of the present application, the audio playing device may prompt an update reminder, and acquire the updated audio file. Compared to the relatively complex existing techniques where the user needs to acquire the updated audio file from the audio content source and send it to the audio playing device, embodiments of the present application can save the time and resources required for transmitting the updated audio file to the audio playing device by the user terminal. Therefore, acquisition efficiency of the updated audio file is improved, and the audio playing device can acquire the updated audio file in a timely manner.

In some embodiments of the present application, in addition to implementing the update prompt and the active acquisition of the audio file, the audio playing device may further perform steps for subscribing to an audio file.

In some embodiments, the above methods described above may further include the following steps:

In step 1, the audio playing device receives an audio file subscription instruction.

In step 2, the audio playing device sends an audio file subscription request to the audio subscription server in response to the audio file subscription instruction. The audio file subscription request may include an identification of an audio file series to be subscribed to.

In some embodiments of the present application, the audio playing device may receive the audio file subscription instruction in the process of playing an audio file. In response to the audio file subscription instruction, the audio playing device may acquire an identification of an audio file series to which the audio file being currently played belongs. The audio playing device can then generate the audio file subscription request according to the identification and send the audio file subscription request to the audio subscription server.

In some embodiments, the audio playing device may be provided with a third hardware module configured to generate an audio file subscription instruction. This may enable the user to subscribe to the audio file series conveniently and quickly. The third hardware module may include, but not limited to, one of the following hardware components: an indicator light that can be used as a physical key; a touch screen; a physical key; a physical knob; a microphone; and a biometric characteristic collection apparatus.

Correspondingly, the audio file subscription instruction may include at least one of the following:

an electrical signal generated when the indicator light on the audio playing device is pressed;

an electrical signal generated when the physical key on the audio playing device is pressed;

an electrical signal generated when the touch screen on the audio playing device is touched;

an electrical signal generated when the knob on the audio playing device is rotated;

a voice signal input into the audio playing device; and

a specified biometric characteristic input into the audio playing device.

In some embodiments, the audio playing device may generate an audio file subscription request according to the identification of the audio file series subscribed to by a user, the address of an audio playing device associated with the user, and the user identification. The audio file subscription request may also include the identification of the audio file series, the address, and the user identification. This way, the audio subscription server or the audio content source can subsequently distinguish audio file series subscribed to by different users, and send, to the audio playing devices, an updated audio file in an audio file series subscribed to by the respective users.

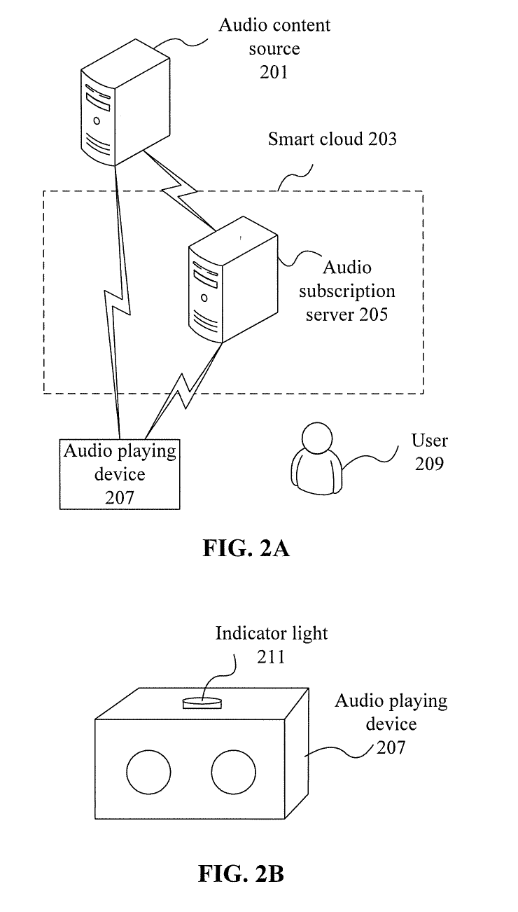

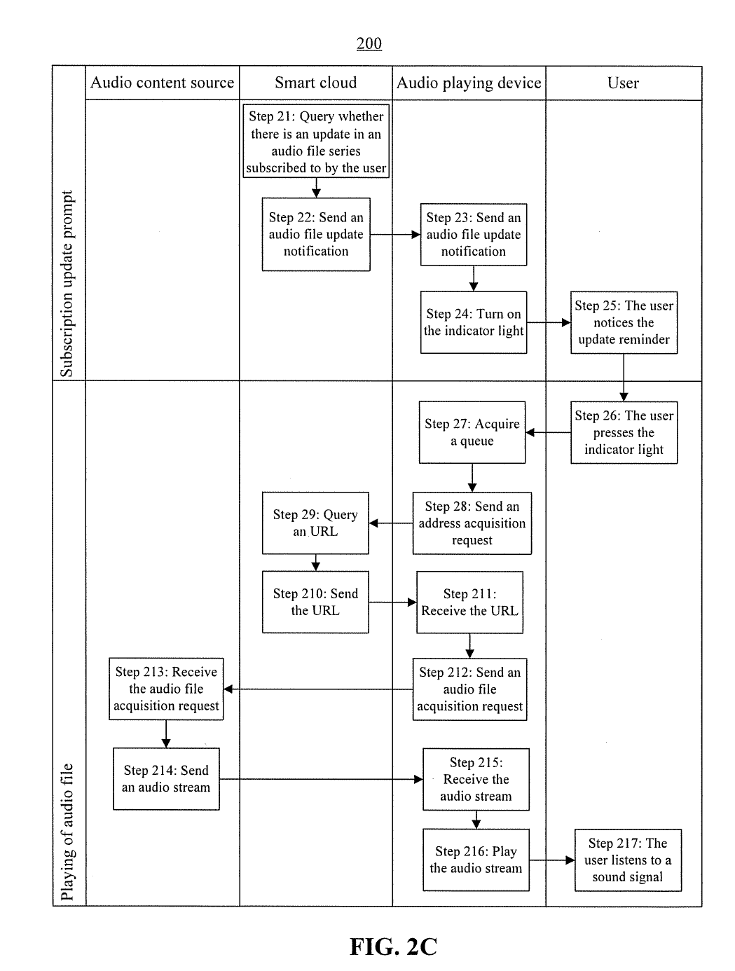

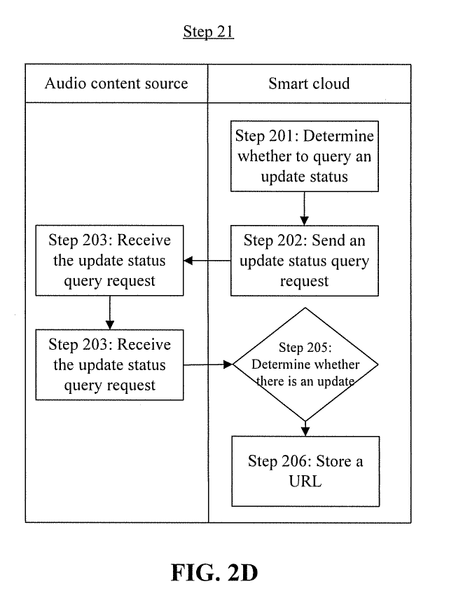

FIG. 2A is a schematic diagram of an implementation scenario according to some embodiments of the present application. For example, embodiments described above with reference to FIG. 1 may be implemented in the implementation scenario shown in FIG. 2A.

As shown in FIG. 2A, this exemplary implementation scenario includes an audio content source 201 (for example, an audio content server of an audio content provider), an smart cloud 203 comprising cloud resources such as audio subscription server 205 (for example, the audio subscription server described with reference to FIGS. 1A and 1B), an audio playing device 207 (such as the audio playing device or the smart speaker described above with reference to FIGS. 1A and 1B), and a user 209. There may be one or more audio content sources in the scenario. For purposes of illustration, the description below uses an example where there is only one audio content source 201 in the scenario.

FIG. 2B is a schematic diagram of an exemplary external structure of audio playing device 207, according to some embodiments the present application. As shown in FIG. 2B, audio playing device 207 includes at least one indicator light 211. In this example, when indicator light 211 is turned on, it indicates that an audio file series subscribed to by user 209 is updated, and there is an updated audio file. When indicator light 211 is turned off, it indicates that there is no updated audio file in the audio file series subscribed to by user 209.

In some embodiments, indicator light 211 may be integrated with or combined with other components, operations of which may trigger performance of certain steps described above with reference to FIG. 1A. For example, in some embodiments, indicator light 211 can be integrated with a physical key provided with a touch screen. Upon certain operations of the physical key, for example, when the physical key is long-pressed or pressed down, the audio playing device may be triggered to acquire the updated audio file. When the touch screen provided on the physical key is tapped, the audio playing device may be triggered to send a request to the smart cloud, for subscribing to an audio file series to which an audio file being currently played by the audio playing device belongs. It should be appreciated that, if the physical key is in a turned-on state before being long-pressed (or pressed down), indicator light 211 may be turned off under the control of the audio playing device after being long-pressed (or pressed down). Alternatively, indicator light 211 may be turned off under the control of the audio playing device after the audio playing device acquires the updated audio file successfully.

FIG. 2C is a schematic diagram of an exemplary update prompting and audio playing process 200 performed by an audio playing device, according to some embodiments of the present application. For example, the update prompting and audio playing process 200 may be applied in the scenario described above with respect to FIG. 2A. In some embodiments, some steps of process 200 can be performed by a computer system. As shown in FIG. 2C, update prompting and audio playing process 200 can include the following steps:

In step 21, the smart cloud queries from the audio content source (for example, a source that provides audio content for subscription, such as audio content source 201) whether there is an update in an audio file series subscribed to by the user. If an update is found through query, then step 22 is performed. If no update is found, the process may end or step 21 repeats.

In some embodiments, step 21 can be performed by an update server in the smart cloud, or in some embodiments, an audio subscription server such as audio subscription server 205 described with reference to FIG. 2A. In the embodiment of the present application, the smart cloud (for example, through the audio subscription server therein) may perform the following sub-steps of step 21, as shown in FIG. 2D. In some embodiments, step 21 may be performed using a computer system.

In step 201, the smart cloud determines, according to a query timing period, whether an update status of a subscribed audio file series can be queried at the current moment. If it is determined that query can be conducted, the process moves to step 202. If it is determined that query is not to be conducted at the current moment, step 201 repeats.

In step 202, the smart cloud sends an update status query request to the audio content source.

In step 203, the audio content source receives the update status query request.

In step 204, the audio content source returns query result. For example, if an updated audio file is found, the audio content source can send, in response to the received update status query request, a URL of the updated audio file in the audio file series to the smart cloud as a query result.

In step 205, the smart cloud parses the query result and determines whether there is an update. For example, the smart cloud may determine whether there is an update by determining whether there is a URL included in the query result. If there is an update, the process moves to step 36. If there is no update based on the query result, the query process for this query timing period may end here.

In step 206, the smart cloud can store the URL included in the query result as a URL of the updated audio file, and further performs step 201 for another query.

Referring again to FIG. 2C, if in step 21, it is determined that there is an update in an audio file series subscribed to by the user, the process 200 moves on to step 22.

In step 22, the smart cloud identifies an audio playing device corresponding to the audio file series in which update occurs, and sends an audio file update notification to the identified audio playing device.

In some embodiments, the smart cloud may acquire a user identification of the user who subscribes to the audio file series where update occurs, according to a mapping relationship between information of the audio file series and user identifications of users who subscribe to the audio file series, as well as information of the audio file series. Further, according to a stored mapping relationship between user identifications and addresses of audio playing devices associated with the respective users, the smart cloud may acquire an address of the audio playing device mapped by the acquired user identification. The smart cloud may then send an audio file update notification to the address of the audio laying device associated with the acquired user identification.

In step 23, the audio playing device receives the audio file update notification.

In step 24, the audio playing device turns on an indicator light on the audio playing device in response to the audio file update notification. This can serve as a prompted update reminder described above with respect to FIG. 1A. As described above, there may be other manners for providing an update reminder in other embodiments.

In step 25, the user notices that the indicator light on the audio playing device is turned on.

In step 26, the user presses the indicator light.

In step 27, the audio playing device acquires an information queue formed by information of subscribed audio file series, in response to an electrical signal (equivalent to the audio file acquisition instruction described with reference to FIG. 1A) triggered when the user presses the indicator light. The information of the subscribed audio file series may be stored in the audio playing device locally after the user successfully subscribes to the audio file series via the audio playing device.

In step 28, when the audio playing device is currently playing an audio file, and it is determined that information of an audio file series to which the audio file being played belongs exists in the information queue, the audio playing device sends an address acquisition request to the smart cloud according to the information of the audio file series to which the audio file belongs. The address acquisition request can include information of the audio file series.

In step 29, according to the received address acquisition request, the smart cloud queries, from the URLs of the updated audio file sent from the audio content source, a URL of an updated audio file corresponding to the information of the audio file series in the address acquisition request. The updated audio file corresponding to the information of the audio file series refers to an audio file that belongs to the audio file series.

In some embodiments of the present application, the URL of an updated audio file may include information of the audio file series to which the audio file belongs. Therefore, it may be determined, by querying the URLs, which audio file series the updated audio file belongs to.

In step 210, the smart cloud sends the queried URL of the updated audio file to the audio playing device.

In step 211, the audio playing device receives the URL of the updated audio file sent by the smart cloud.

In step 212, the audio playing device sends, according to the received URL, an audio file acquisition request to an audio content source (i.e., the audio content source) associated with the URL.

In step 213, the audio content source receives the audio file acquisition quest.

In step 214, the audio content source sends a corresponding audio stream to the audio playing device according to the updated audio file requested by the audio file acquisition request.

In step 215, the audio playing device receives the audio stream sent by the audio content source.

In step 216, the audio playing device sends a sound signal by playing the received audio stream.

In step 217, the user listens to the sound signal.

In view of the above, according to some embodiments of the present application, the update reminder may be prompted by the audio playing device. This way, the prompt generally will not be mixed in numerous other update prompts. The user may be notified in a timely manner, according to the update prompt reminder, that there are audio file updates. The audio playing device can then acquire the updated audio file in response to the audio file acquisition instruction. This may help avoid the problem that the audio playing device (such as a smart speaker) cannot acquire updated audio files in a timely manner, which easily occurs with existing techniques. At the same time, compared with existing techniques, the process of acquiring the updated audio file by the audio playing device is simplified. The efficiency of acquiring updated audio file by the audio playing device can be improved, and updated audio files can be acquired in a timely manner.

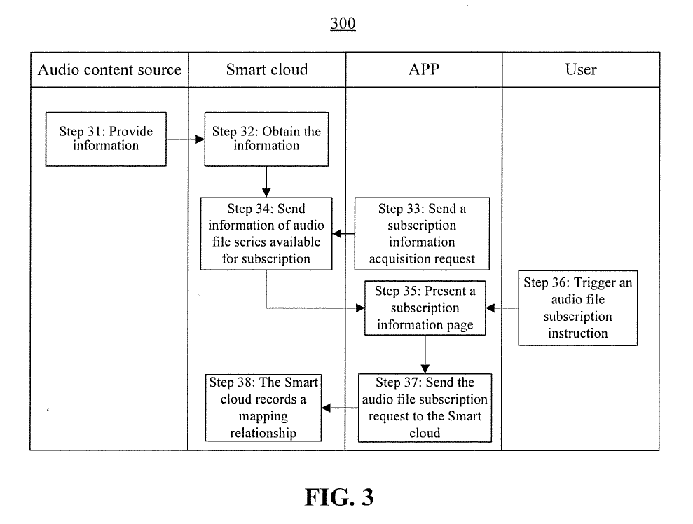

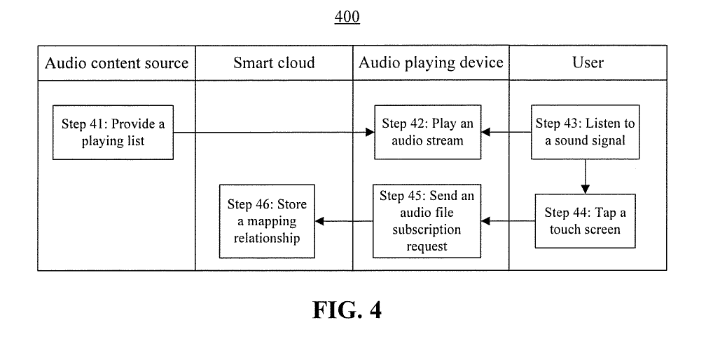

In some embodiments, subscription to an audio file series may be implemented through the processes as shown in FIG. 3 and FIG. 4. In some embodiments, some steps can be performed using a computer system.

In some embodiments, a user can subscribe to an audio file series by using an Application (APP) on the user terminal. FIG. 3 is a schematic flowchart of an exemplary method 300 involving subscription to an audio file series according to some embodiments of the present application. As shown in FIG. 3, subscription method 300 may include the following steps:

In step 31, an audio content source sends, to the smart cloud, information of audio file series available for subscription.

In step 32, the smart cloud obtains the information of the audio file series available for subscription sent by the audio content sources.

In step 33, after receiving a subscription information page refresh instruction, the APP sends a subscription information acquisition request to the smart cloud.

In step 34, after receiving the subscription information acquisition request, the smart cloud sends, to the APP, the information of the audio file series available for subscription.

In step 35, the APP presents a subscription information page including the information of the audio file series available for subscription.

In step 36, the user selects one or more pieces of information of the audio file series available for subscription presented on the subscription information page. For example, the user may then click a “Confirm” button (or other mechanisms of inputting confirmation through an interface) on the page to trigger an audio file subscription instruction.

In step 37, the APP sends an audio file subscription request to the smart cloud in response to the audio file subscription instruction. The audio file subscription request can include a user identification, an address of an audio playing device configured to receive the audio file update notification, and the user-selected information of the audio file series available for subscription.

In step 38, according to the audio file subscription request sent by the APP, the smart cloud stores a mapping relationship between the user identification, the address of the audio playing device configured to receive the audio file update notification, and the user-selected information of the audio file series available for subscription. Thereafter, in some embodiments, the smart cloud may send to the APP, a notification message indicating that the subscription is successful.

In some embodiments, a user can subscribe to an audio file series by using the audio playing device. FIG. 4 is a schematic flowchart of an exemplary method 400 involving subscription to an audio file series according to some embodiments of the present application. In some embodiments, some steps of the method can be performed using a computer system. As shown in FIG. 4, subscription method 400 may include the following steps:

In step 41, the audio content source provides a play list to the audio playing device. The play list may include one or more audio streams corresponding to multiple audio files respectively.

In step 42, the audio playing device plays the audio streams in the play list provided by the audio content source.

In step 43, the user listens to a sound signal that is sent by the audio playing device by playing the audio steams in the play list.

In step 44, the user clicks the touch screen on the audio playing device after hearing a desirable sound signal. It is appreciated that in some embodiments, the audio playing device may include other inputting mechanisms through which the user can operate the audio playing device. The touch screen mentioned above is only exemplary.

In step 45, after detecting an electrical signal generated by a click on the touch screen, the audio playing device is triggered to send an audio file subscription request to the smart cloud. The audio file subscription request can include information of an audio file series to which the audio stream being played when the touch screen is clicked belongs. In some embodiments, the audio file subscription request may further include a user identification, and an address of an audio playing device configured to receive an audio file update notification.

In step 46, according to the received audio file subscription request, the smart cloud stores a mapping relationship between the user identification, the address of the audio playing device configured to receive the audio file update notification, and the information of the audio file series included in the audio file subscription request. Thereafter, in some embodiments, the smart cloud may send, to the audio playing device, a notification message indicating that the subscription is successful.

In view of the above, according to some embodiments of the present application, the process of subscribing to the audio file series by the audio playing device may be independent of the APP. That is, the audio playing device can undertake the task of subscribing to the audio file series.

According to the embodiments described above with reference to FIGS. 3 and 4, audio file subscription methods are provided. The user can use a relatively convenient and quick subscription method, and select desired audio file series flexibly, thereby improving user experience. For example, when the user is in a location close to the audio playing device, the user may directly press the indicator light on the audio playing device, to subscribe to the audio file series to which the audio file being currently played belongs. Alternatively, when the user is away from the audio playing device, the user may subscribe to the audio file series by using an APP on the user terminal carried by the user.

In some embodiments, the subsequent update prompt may be performed by the audio playing device regardless of which subscription method is used. The update reminder prompted by the audio playing device generally will not be mixed in numerous other update prompts. Therefore, it can help avoid the problem in the existing technology that the update prompt is mixed in other update prompts and thus the audio playing device cannot obtain the updated audio file in a timely manner.

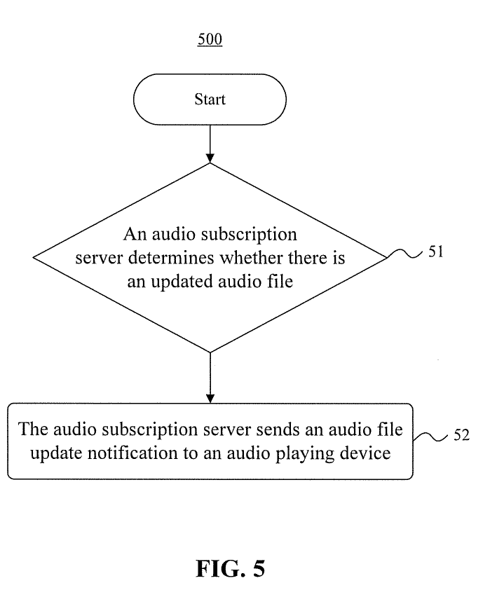

According to some embodiments of the present application, update notification sending methods are provided. FIG. 5 is a schematic flowchart of an exemplary update notification sending method 500 according to some embodiments of the present application. The method can be performed, for example, by audio subscription server 205 as described in FIG. 2A. In some embodiments, some steps of the update notification sending methods can be performed using a computer system. As shown in FIG. 5, exemplary method 500 can include the following steps shown in FIG. 5:

In step 51, audio subscription server 205 determines whether there is an updated audio file in an audio file series provided by an audio content source. If it is determined that there is an updated audio file, the process moves on to step 52. If it is determined that there is no updated audio file, the process may end, or repeat step 51.

Specifically, audio subscription server 205 may acquire, via an interface between the audio subscription server and one or more audio content sources, information of the updated audio file sent by each audio content source. Based on the acquired information, audio subscription server 205 may determine whether there is an updated audio file in the audio file series provided by a corresponding audio content source.

The information of the updated audio file may be, but not limited to, a URL of the updated audio file.

The updated audio file may be, but not limited to, an updated audio file in a subscribed audio file series.

In some embodiments, if the updated audio file is an updated audio file in a subscribed audio file series, step 51 may include the following sub-steps:

querying information of updated audio files sent by one or more audio content sources, by the audio subscription server according to information of the subscribed audio file series, to determine whether there is information of an updated audio file matching the information of the subscribed audio file series from; and

determining that there is an updated audio file in the subscribed audio file series, when information of an updated audio file matching the information of the subscribed audio file series is found through query. If no matching information is found, it can be determined that there is no updated audio file in the subscribed audio file series.

The information of the subscribed audio file series may be a unique identification of the subscribed audio file. For example; the information may be acquired from an audio series subscription request sent by an audio playing device to the audio subscription server, and stored in the audio subscription server locally.

In step 52, audio subscription server 205 sends an audio file update notification to an audio playing device. The audio playing device can acquire the updated audio file according to the received notification.

In some embodiments, the audio playing device mentioned here may be a user terminal. In some embodiments, the audio playing device may be an audio/video player, such as a speaker. In cases where the user terminal is the audio playing device, the audio playing device may prompt an update reminder in response to the received audio file update notification. The user terminal may receive an audio file acquisition instruction subsequently, and acquire an updated audio file in response to the audio file acquisition instruction.

In some embodiments, the method shown in FIG. 5 may further include the following steps:

receiving, by audio subscription server 205 after sending the audio file update notification to the audio playing device, an address acquisition request sent by the audio playing device; and

acquiring an acquisition address of the updated audio file in response to the address acquisition request and sending the acquisition address to the audio playing device.

According to the received acquisition address, the audio playing device may send an acquisition request for the updated audio file to the audio content source.

In some embodiments, in addition to the above steps, the audio subscription server may further store the information of the subscribed audio file series. For example, the audio subscription server may obtain information of audio file series available for subscription that are sent by at least one audio content source. The audio subscription server can send, to the audio playing device, the information of the audio file series available for subscription. The audio subscription server can receive information selected by the audio playing device from the information of the audio file series available for subscription, and store the selected information as the information of the subscribed audio file series.

Compared to the techniques where the audio content sources send audio file update notifications to the individual user terminals, embodiments of the present application allow the audio file update notifications to be sent uniformly by the audio subscription server. This can help avoid the consumption of resources when sending the notifications by an audio content source to each audio playing device separately. Further, with the above-described embodiments, the updated audio files can be sent to an audio playing device directly, without going through the user terminal. Therefore, the audio playing device can acquire the updated audio files in a timely manner.

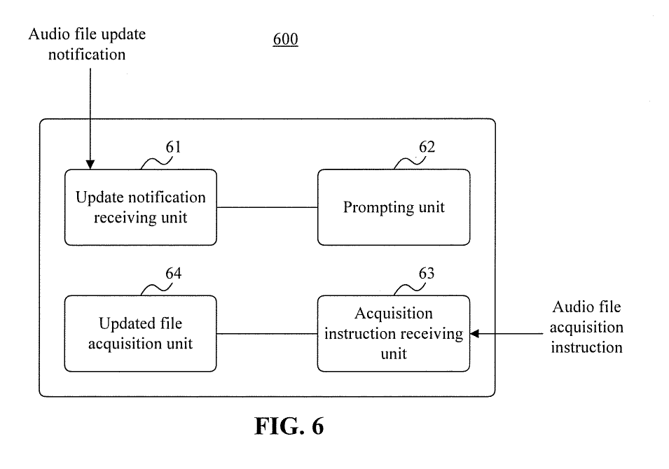

According to some embodiments of the present application, audio playing devices are provided. Audio playing devices according to some embodiment of the present application can help solve the problem that an audio playing device cannot timely acquire updated audio files. FIG. 6 is a schematic diagram of an exemplary structure of an audio playing device 600 according to some embodiments of the present application. As shown in FIG. 6, audio playing device 600 may include the following functional units:

an update notification receiving unit 61 configured to receive an audio file update notification;

a prompting unit 62 configured to prompt an update reminder in response to the audio file update notification received by the update notification receiving unit 61;

an acquisition instruction receiving unit 63 configured to receive an audio file acquisition instruction; and

an updated file acquisition unit 64 configured to acquire an updated audio file in response to the audio file acquisition instruction received by the acquisition instruction receiving unit 63.

In some embodiments, the audio playing device is provided with a first hardware module configured to present the update prompt reminder, and a second hardware module configured to generate the audio file acquisition instruction. For example, the first hardware module can include at least one of the following hardware components: an indicator light; a touch screen; a non-touch display screen; and a loudspeaker. The second hardware module can include at least one of the following hardware components: an indicator light that can be used as a physical key; a touch screen; a physical key; a physical knob; and a biometric characteristic collection apparatus. The first hardware module and the second hardware module can be integrated in a same hardware module, or the first hardware module and the second hardware module can be different hardware modules.

In order that the update prompt easily draws the user's attention, in some embodiments, the prompting unit 62 can be configured to execute at least one of the following operations:

an operation enabling the indicator light of the audio playing device to be in a pre-set state;

sending a pre-set sound signal; and

displaying pre-set information on a display screen of the audio playing device.

In some embodiments, the audio file acquisition instruction may include, but not limited to, at least one of the following:

an electrical signal generated when the indicator light on the audio playing device is pressed;

an electrical signal generated when the physical key on the audio playing device is pressed;

an electrical signal generated when the touch screen on the audio playing device is touched;

an electrical signal generated when the knob on the audio playing device is rotated;

a voice signal input into the audio playing device; and

a specified biometric characteristic input into the audio playing device.

In some embodiments, audio playing device 600 of the present application may further be configured to subscribe to an audio file series. For example, the audio playing device may subscribe to the audio file series by using a subscription instruction receiving unit and a subscription request sending unit. The subscription instruction receiving unit can be configured to receive an audio file subscription instruction. The subscription request sending unit can be configured to send an audio file subscription request to the audio subscription server in response to the audio file subscription instruction.

In some embodiments, the subscription instruction receiving unit may be configured to receive the audio file subscription instruction when the audio playing device plays an audio file. The subscription request sending unit may be configured to acquire an identification of an audio file series to which the audio file being currently played belongs, and generate the audio file subscription request according to the identification. The subscription request sending unit may then send the audio file subscription request to the audio subscription server.

In some embodiments, the subscription request sending unit may be configured to generate the audio file subscription request according to: the identification of the audio file series to which the audio file being currently played belongs, an address of the audio playing device, and a user identification.

In order that the user can subscribe to the audio file series conveniently and quickly, the audio playing device may be provided with an audio file subscription button. The audio file subscription instruction described in the foregoing may further include: an electrical signal triggered when the audio file subscription button of the audio playing device is pressed.

In some embodiments, the updated file acquisition unit 64 may acquire the updated audio file by performing the following steps:

sending an address acquisition request to the audio subscription server;

receiving, from the audio subscription server, an acquisition address of the updated audio file;

sending an audio file acquisition request to the audio content source according to the acquisition address; and

receiving the updated audio file sent by the audio content source according to the audio file acquisition request.

In some embodiments, the address acquisition request may include at least one of the following information:

an identification of an audio file series to which a subscribed audio file found locally in the audio playing device belongs;

an identification of an audio file series that is acquired from the audio file update notification; and

a user identification.

In some embodiments, the updated file acquisition unit 64 may acquire the updated audio file by performing the following steps:

sending an audio file acquisition request to the audio content source according to an acquisition address of the updated audio file, the acquisition address being obtained from the audio file update notification; and

receiving the updated audio file that is sent by the audio content source according to the audio file acquisition request.

According to some embodiments, audio playing device 600 may be, but not limited to, a smart TV, a router, or a speaker.

In view of the above-described embodiments, audio playing device 600 may prompt an update reminder, and acquire the updated audio file. The relatively complex manner in the existing techniques where the user needs to acquire the updated audio file from the audio content source and send the updated audio file to the audio playing device can be avoided. This way, time required for transmitting the updated audio file to the audio playing device by the user terminal can be saved. Therefore, the acquisition efficiency of the updated audio file is improved, and the audio playing device can acquire the updated audio file in a timely manner.

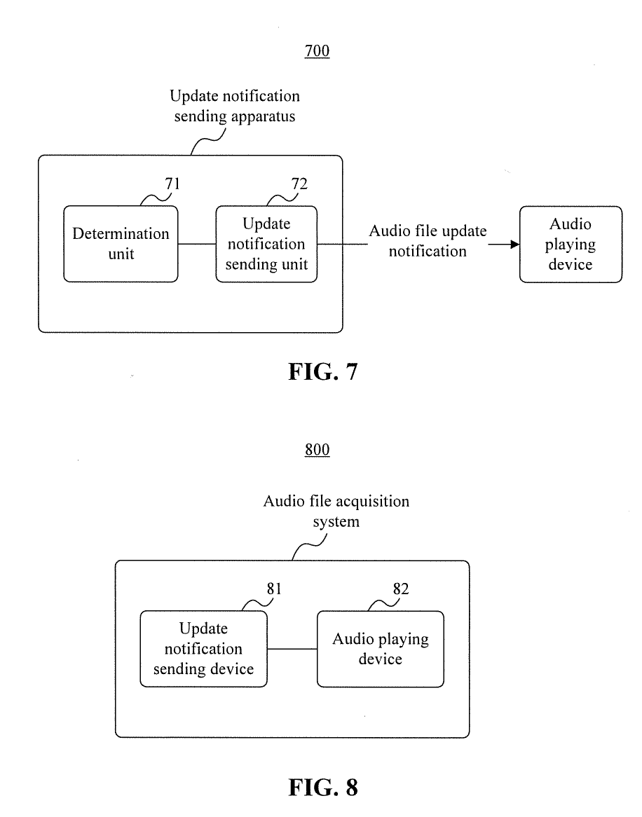

According to some embodiments of the present application, update notification sending devices are provided. FIG. 7 is a schematic diagram of an exemplary structure of an update notification sending device 700 according to some embodiments of the present application. As shown in FIG. 7, including the following functional units:

a determination unit 71 configured to determine whether there is an updated audio file in an audio file series provided by each audio content source; and

an update notification sending unit 72 configured to send an audio file update notification to an audio playing device, when the determination result obtained by the determination unit 71 indicates that there is an updated audio file. The audio playing device can then acquire the updated audio file according to the received notification.

The audio playing device may be the audio playing device described with reference to FIG. 1A, or a user terminal.

In some embodiments, the audio file series may be a subscribed audio file series. The determination unit 71 may be further configured to query information of updated audio files sent by one or more audio content source, according to information of the subscribed audio file series, to determine whether there is information of an updated audio file matching the information of the subscribed audio file series. The determination unit 71 can be further configured to determine there is an updated audio file in the subscribed audio file series, if an updated audio file with information matching the information of the subscribed audio file series is found through query. Alternative, the determination unit 71 can determine that there is no updated audio file in the subscribed audio file series, if no such matching information is found.

In some embodiments, the update notification sending device 700 may further be configured to provide, to the audio playing device, an acquisition address of the updated audio file. For example, the update notification sending device 700 may perform the function by using an acquisition request receiving unit and an address sending unit included therein. The acquisition request receiving unit can be configured to receive an address acquisition request sent by the audio playing device, after the update notification sending unit 72 sends the audio file update notification to the audio playing device. The address sending unit can be configured to acquire an acquisition address of the updated audio file in response to the address acquisition request, and send the acquisition address to the audio playing device.

In some embodiments, the acquisition address of the updated file may be provided to the audio playing device by using the update notification sending unit 72. For example, the update notification sending unit 72 may be further configured to acquire the acquisition address of the updated audio file, when it is determined by the determination unit 71 that there is an updated audio file. The update notification sending unit 72 can send the audio file update notification including the acquisition address to the audio playing device.

In some embodiments, the update notification sending device 700 may further be configured to store a subscription record of one or more users. The subscription record mentioned here may include information of the audio file series subscribed to the users. For example, the subscription record of the user may be stored via the following units included in the update notification sending device 700:

an information obtaining unit configured to obtain information of audio file series that are sent by each audio content source and available for subscription;

an information sending unit configured to send, to an audio playing device, the information of the audio file series available for subscription;

a receiving unit configured to receive information selected by the audio playing device from the information of the audio file series available for subscription; and

a storing unit configured to store the selected information as the information of the subscribed audio file series.

In general, the modules/units (and any sub-modules/units) described herein such as those described above with reference to FIG. 6 and FIG. 7, can be a packaged functional hardware unit designed for use with other components (e.g., portions of an integrated circuit) and/or a part of a program (stored on a computer readable medium) that preforms is a particular function of related functions. The module/unit can have entry and exit points and can be written in a programming language, such as, for example, Java, Lua, C, or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a computer readable medium, such as a compact disc, digital video disc, flash drive, magnetic disc, or any other non-transitory medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedding in firmware, such as an EPROM. It will be further appreciated that hardware modules can be comprised of connected logic units, such as gates and flip-flops, and/or can be comprised of programmable units, such as programmable gate arrays or processors.

According to some embodiments of the present application, audio file acquisition systems are provided. For example, audio file acquisition systems according to some embodiments can help solve the problem that an audio playing device cannot acquire updated audio files in a timely manner. FIG. 8 is a schematic diagram of an exemplary structure of an audio file acquisition system 800 according to some embodiments of the present application. As shown in FIG. 8, the audio file acquisition system 800 can include an update notification sending device 81 and an audio playing device 82.

The update notification sending device 81 is configured to send an audio file update notification to the audio playing device. The audio playing device 82 is configured to receive the audio file update notification, and prompt an update reminder in response to the audio file update notification. After receiving an audio file acquisition instruction, the audio playing device can acquire an updated audio file in response to the audio file acquisition instruction.

In some embodiments, the update notification sending device 81 may be a user terminal. In some embodiments, it may be part of an audio content source, or an audio subscription server, such as that described above with reference to FIGS. 1A and 1B.

In some embodiments, prompting an update reminder by the audio playing device 82 may include, but not limited to, at least one of the following:

enabling an indicator light of the audio playing device to be in a pre-set state;

sending a pre-set sound signal; and

displaying pre-set information on a display screen of the audio playing device.

In some embodiments, the audio playing device may be further provided with: a first hardware module configured to present the update reminder, and a second hardware module configured to generate the audio file acquisition instruction.

The first hardware module can include at least one of the following hardware components: an indicator light; a touch screen; a non-touch display screen; and a loudspeaker. The second hardware module can include at least one of the following hardware components: an indicator light that can be used as a physical key; a touch screen; a physical key; a physical knob; and a biometric characteristic collection apparatus.

In some embodiments, the first hardware module and the second hardware module can be integrated in a same hardware module, or the first hardware module and the second hardware module are different hardware modules.

In some embodiments, the audio playing device may be a smart TV, a router, or a speaker.

In some embodiments, the audio file acquisition instruction may include, but not limited to, one of the following:

an electrical signal generated when the indicator light on the audio playing device is pressed;

an electrical signal generated when the physical key on the audio playing device is pressed;

an electrical signal generated when the touch screen on the audio playing device is touched;

an electrical signal generated when the knob on the audio playing device is rotated;

a voice signal input into the audio playing device; and

a specified biometric characteristic input into the audio playing device.

In some embodiments, the audio playing device may be further configured to receive the audio file subscription instruction; and send an audio file subscription request to the audio subscription server in response to the audio file subscription instruction. For example these functions may be similar to those subscription method steps described above with respect to FIG. 1B. In some embodiments, the audio file subscription instruction may include: an electrical signal triggered when an audio file subscription button of the audio playing device is pressed.

According to the above systems according to some embodiments of the present application, the audio playing device may prompt an update reminder, and acquire the updated audio file. The can help avoid the relatively complex manner in which the user needs to acquire the updated audio file from the audio content source and send the updated audio file to the audio playing device. Therefore, the time required for transmitting the updated audio file to the audio playing device by the user terminal can be saved. The acquisition efficiency of the updated audio file is improved, and the audio playing device can acquire the updated audio file in a timely manner.

It should be appreciated that, the embodiments of the present invention may be provided as methods, systems, or computer program products. Therefore, the present invention may be implemented as a hardware apparatus, a software module, or an embodiment combing software and hardware. Moreover, the present invention may be manifested in a computer program product stored on one or more computer readable storage media (including, but not limited to, a magnetic disk memory, a CD-ROM, an optical memory, and the like) including computer readable programs, which can be executed by one or more processors.

The present invention is described with reference to flowcharts and/or block diagrams illustrating the methods, devices (systems) and computer program products according to some embodiments of the present invention. It should be appreciated that a computer program may be used to implement the steps and/or blocks in the flowcharts and/or block diagrams and combinations of processes and/or blocks in the flowcharts and/or block diagrams. The computer program instructions may be provided for a general-purpose computer, a special-purpose computer, an embedded processor, or a processor of any other programmable processing device, which can perform the processes described above as an apparatus. The instructions executed by a computer or a processor of any other programmable processing device may enable such apparatuses to perform the specified functions in one or more processes in the accompanying flowcharts and/or in one or more blocks in the block diagrams. These computer program instructions may also be stored in a computer readable memory that can instruct the computer or any other programmable processing device to function in a particular manner to implement the specified functions in one or more processes in the flowcharts and/or in one or more blocks in the block diagrams.

These computer program instructions may also be loaded onto a computer or another programmable data processing device, such that a series of operations and steps can be performed on the computer or another programmable device, thereby generating computer-implemented processing. Therefore, the instructions executed on the computer or another programmable device cause performance of the specified functions in one or more processes in the flowcharts and/or in one or more blocks in the block diagrams.

For example, a computer device can include one or more processors (CPU), an input/output interface, a network interface, and a memory. The memory may include a volatile memory, a random access memory (RAM) and/or a non-volatile memory or the like in a computer readable medium, for example, a read-only memory (ROM) or a flash RAM.

The memory is an example of the computer readable medium. For example, the computer readable-medium may include a set of instructions for instructing a computer device (which may be a personal computer, a server, a network device, or the like) or a processor to perform a part of the steps of the methods described in the embodiments of the present invention. The foregoing storage medium may include, for example, any medium that can store a program code, such as a USB flash disk, a removable hard disk, a Read-Only Memory (ROM), a Random Access Memory (RAM), a magnetic disk, or an optical disc. The storage medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, any other memory chip or cartridge, and networked versions of the same.

It should be further noted that, the terms “include,” “comprise,” or other variations thereof are intended to cover non-exclusive inclusion, so that a process, method, product or device including a series of elements not only includes the elements, but can also include other elements not clearly listed, or inherent elements of the process, method, product or device. Without any specific limitations, an element defined by “including a(an) . . . ” does not exclude processes, methods, products or devices including other elements not listed therein.

The above descriptions are merely embodiments of the present application, and are not intended to limit the present application. It should be appreciated that the present application may have various modifications and variations. Any modification, equivalent replacement, improvement or the like made without departing from the spirit and principle of the present application should all fall within the scope of claims of the present application.

1. An audio file acquisition method, comprising:
receiving an audio file update notification by an audio playing device;
prompting an update reminder by the audio playing device in response to the audio file update notification;
receiving an audio file acquisition instruction by the audio playing device; and
acquiring an updated audio file by the audio playing device in response to the audio file acquisition instruction.

2. (canceled)

3. The audio file acquisition method of claim 1, wherein the audio playing device is a smart TV, a router, or a speaker.

4. The audio file acquisition method of claim 1, wherein prompting the update reminder by the audio playing device comprises at least one of the following:
executing, by the audio playing device, an operation enabling an indicator light of the audio playing device to be in a pre-set state;
sending, by the audio playing device, a pre-set sound signal; and
displaying, by the audio playing device, pre-set information on a display screen of the audio playing device.

5. The audio file acquisition method of claim 1, wherein the audio file acquisition instruction comprises at least one of the following:
an electrical signal generated when an indicator light on the audio playing device is pressed;
an electrical signal generated when a physical key on the audio playing device is pressed;
an electrical signal generated when a touch screen on the audio playing device is touched;
an electrical signal generated when a knob on the audio playing device is rotated;
a voice signal input into the audio playing device; and
a specified biometric characteristic input into the audio playing device.

6. The audio file acquisition method of claim 1, further comprising:
receiving, by the audio playing device, an audio file subscription instruction; and
sending, by the audio playing device, an audio file subscription request to an audio subscription server in response to the audio file subscription instruction.

7. The audio file acquisition method of claim 6,
wherein receiving, by the audio playing device, the audio file subscription instruction comprises:
receiving, by the audio playing device, the audio file subscription instruction in the process of playing an audio file; and
wherein sending, by the audio playing device, the audio file subscription request to the audio subscription server in response to the audio file subscription instruction comprises:
acquiring, by the audio playing device, an identification of an audio file series to which the audio file being played belongs; and
generating, by the audio playing device, the audio file subscription request according to the identification.

8. The audio file acquisition method of claim 6, wherein generating, by the audio playing device, the audio file subscription request according to the identification comprises:
generating, by the audio playing device, the audio file subscription request according to the identification, an address of the audio playing device, and a user identification.

9. (canceled)

10. The audio file acquisition method of claim 6, wherein the audio file subscription instruction comprises at least one of the following:
an electrical signal generated when an indicator light on the audio playing device is pressed;
an electrical signal generated when a physical key on the audio playing device is pressed;
an electrical signal generated when a touch screen on the audio playing device is touched;
an electrical signal generated when a knob on the audio playing device is rotated;
a voice signal input into the audio playing device; and
a specified biometric characteristic input into the audio playing device.

11. The audio file acquisition method of claim 1, wherein acquiring the updated audio file by the audio playing device in response to the audio file acquisition instruction comprises:
sending, by the audio playing device, an address acquisition request to an audio subscription server;
receiving, by the audio playing device, an acquisition address of the updated audio file, the acquisition address being sent by the audio subscription server;
sending, by the audio playing device, an audio file acquisition request to an audio content source according to the acquisition address; and
receiving, by the audio playing device, the updated audio file sent by the audio content source according to the audio file acquisition request.

12. The audio file acquisition method of claim 11, wherein the address acquisition request comprises at least one of the following:
an identification of an audio file series to which a locally stored subscribed audio file belongs;
an identification of an audio file series acquired from the audio file update notification; and
a user identification.

13. The audio file acquisition method of claim 1, wherein acquiring the updated audio file by the audio playing device in response to the audio file acquisition instruction comprises:
sending, by the audio playing device, an audio file acquisition request to an audio content source according to an acquisition address of the updated file, the acquisition address being obtained from the audio file update notification; and
receiving, by the audio playing device, the updated audio file sent by the audio content source according to the audio file acquisition request.

14. An update notification sending method, comprising:
determining, by an audio subscription server, whether there is an updated audio file in an audio file series provided by an audio content source; and
sending, by the audio subscription server, an audio file update notification to an audio playing device, in response to a determination that there is an updated audio file.

15. The update notification sending method of claim 14, wherein the audio file series is a subscribed audio file series, and wherein determining, by the audio subscription server, whether there is an updated audio file in an audio file series provided by an audio content source comprises:
querying information of updated audio files from the audio content source, by the audio subscription server according to information of the subscribed audio file series; and
determining whether an updated audio file includes information matching the information of the subscribed audio file series.

16. The update notification sending method of claim 14, wherein after sending, by the audio subscription server, the audio file update notification to the audio playing device, the method further comprises:
receiving, by the audio subscription server, an address acquisition request sent by the audio playing device;
acquiring, by the audio subscription server, an acquisition address of the updated audio file in response to the address acquisition request; and
sending, by the audio subscription server, the address of the updated audio file to the audio playing device.

17. The update notification sending method of claim 14, wherein sending, by the audio subscription server, the audio file update notification to the audio playing device comprises:
acquiring, by the audio subscription server, an acquisition address of the updated audio file in response to the determination that the updated audio file in an audio file series is provided by the audio content source; and
sending the audio file update notification including the acquisition address to the audio playing device.

18. The update notification sending method of claim 14, further comprising:
obtaining, by the audio subscription server from the audio content source, information of audio file series available for subscription;
sending, to the audio playing device, the information of the audio file series available for subscription;
receiving information selected by the audio playing device from the information of the audio file series available for subscription; and
storing the selected information as information of subscribed audio file series.

19. The update notification sending method of claim 14, wherein the audio playing device comprises: a speaker.

20. An audio playing device, comprising:
an update notification receiving unit configured to receive an audio file update notification;
a prompting unit configured to prompt an update reminder in response to the audio file update notification;
an acquisition instruction receiving unit configured to receive an audio file acquisition instruction; and
an updated file acquisition unit configured to acquire an updated audio file in response to the audio file acquisition instruction.

21. The audio playing device of claim 20, wherein the audio playing device further comprises a first hardware module configured to present the update reminder, and a second hardware module configured to generate the audio file acquisition instruction;
wherein the first hardware module comprises at least one of the following:
an indicator light, a touch screen, a non-touch display screen, and a loudspeaker;
wherein the second hardware module comprises at least one of the following:
an indicator light that can be used as a physical key, a touch screen, a physical key, a physical knob, and a biometric characteristic collection apparatus; and
wherein the first hardware module and the second hardware module are integrated in a same hardware module, or the first hardware module and the second hardware module are different hardware modules.

22. The audio playing device of claim 20, wherein the audio playing device is one of a smart TV, a router, or a speaker.

23. The audio playing device of claim 20, wherein the prompting unit is configured to execute at least one of the following:
an operation enabling an indicator light of the audio playing device to be in a pre-set state;
sending a pre-set sound signal; and
displaying pre-set information on a display screen of the audio playing device.

24. The audio playing device of claim 21, wherein the audio file acquisition instruction comprises at least one of the following:
an electrical signal generated when the indicator light on the audio playing device is pressed;
an electrical signal generated when the physical key on the audio playing device is pressed;
an electrical signal generated when the touch screen on the audio playing device is touched;
an electrical signal generated when the knob on the audio playing device is rotated;
a voice signal input into the audio playing device; and
a specified biometric characteristic input into the audio playing device.

25. The audio playing device of claim 21, wherein the audio playing device further comprises:
a subscription instruction receiving unit configured to receive an audio file subscription instruction; and
a subscription request sending unit configured to send an audio file subscription request to an audio subscription server in response to the audio file subscription instruction.

26. The audio playing device of claim 25, wherein:
the subscription instruction receiving unit is configured to receive the audio file subscription instruction in the process of playing an audio file by the audio playing device; and
the subscription request sending unit is configured to:
acquire an identification of an audio file series to which the audio file being played belongs;
generate the audio file subscription request according to the identification; and
send the audio file subscription request to the audio subscription server.

27. The audio playing device of claim 26, wherein:
the subscription request sending unit is further configured to generate the audio file subscription request according to the identification, an address of the audio playing device, and a user identification.

28. The audio playing device of claim 25, wherein the audio playing device comprises a third hardware module configured to generate the audio file subscription instruction;
wherein the third hardware module comprises at least one of the following:
an indicator light that can be used as a physical key, a touch screen; a physical key, a physical knob, a microphone, and a biometric characteristic collection apparatus.

29. The audio playing device of claim 28, wherein the audio file subscription instruction comprises at least one of the following:
an electrical signal generated when the indicator light on the audio playing device is pressed;
an electrical signal generated when the physical key on the audio playing device is pressed;
an electrical signal generated when the touch screen on the audio playing device is touched;
an electrical signal generated when the knob on the audio playing device is rotated;
a voice signal input into the audio playing device; and
a specified biometric characteristic input into the audio playing device.

30. An update notification sending device, comprising:
a determination unit configured to determine whether there is an updated audio file in an audio file series provided by an audio content source; and
an update notification sending unit configured to send an audio file update notification to an audio playing device, in response to a determination that there is an updated audio file.

31. The update notification sending device of claim 30, further comprising:
an acquisition request receiving unit configured to receive an address acquisition request sent by the audio playing device, after the update notification sending unit sends the audio file update notification to the audio playing device; and
an address sending unit configured to acquire an acquisition address of the updated audio file in response to the address acquisition request and send the address to the audio playing device.

32. The update notification sending device of claim 30, wherein:
the update notification sending unit is configured to:
acquire the acquisition address of the updated audio file in response to the determination that there is an updated audio file; and
send the audio file update notification including the acquisition address to the audio playing device.

33. The update notification sending device of claim 30, further comprising:
an information obtaining unit configured to obtain information of audio file series that are sent by an audio content source and available for subscription;
an information sending unit configured to send, to the audio playing device, the information of the audio file series available for subscription
a receiving unit configured to receive information selected by the audio playing device from the information of the audio file series available for subscription; and
a storing unit configured to store the selected information as information of subscribed audio file series.

34. An audio file acquisition system, comprising an audio playing device and an update notification sending device, wherein:
the update notification sending device is configured to send an audio file update notification to the audio playing device; and
the audio playing device is configured to:
receive the audio file update notification;
prompt an update reminder in response to the audio file update notification;
receive an audio file acquisition instruction; and
acquire an updated audio file in response to the audio file acquisition instruction.

35-39. (canceled)

40. A non-transitory computer readable medium that stores a set of instructions that are executable by at least one processor of an audio playing device to perform an audio file acquisition method, the method comprising:
receiving an audio file update notification;
prompting an update reminder in response to the audio file update notification;
receiving an audio file acquisition instruction; and
acquiring an updated audio file in response to the audio file acquisition instruction.

41. The non-transitory computer readable medium of claim 40, wherein the audio playing device is a smart TV, a router, or a speaker.

42. The non-transitory computer readable medium of claim 40, wherein prompting the update reminder by the audio playing device comprises at least one of the following:
executing, by the audio playing device, an operation enabling an indicator light of the audio playing device to be in a pre-set state;
sending, by the audio playing device, a pre-set sound signal; and
displaying, by the audio playing device, pre-set information on a display screen of the audio playing device.

43. The non-transitory computer readable medium of claim 40, wherein the audio file acquisition instruction comprises at least one of the following:
an electrical signal generated when an indicator light on the audio playing device is pressed;
an electrical signal generated when a physical key on the audio playing device is pressed;
an electrical signal generated when a touch screen on the audio playing device is touched;
an electrical signal generated when a knob on the audio playing device is rotated;
a voice signal input into the audio playing device; and
a specified biometric characteristic input into the audio playing device.

44. The non-transitory computer readable medium of claim 40, wherein the audio file acquisition method further comprises:
receiving, by the audio playing device, an audio file subscription instruction; and
sending, by the audio playing device, an audio file subscription request to an audio subscription server in response to the audio file subscription instruction.

45. The non-transitory computer readable medium of claim 44,
wherein receiving, by the audio playing device, the audio file subscription instruction comprises:
receiving, by the audio playing device, the audio file subscription instruction in the process of playing an audio file; and
wherein sending, by the audio playing device, the audio file subscription request to the audio subscription server in response to the audio file subscription instruction comprises:
acquiring, by the audio playing device, an identification of an audio file series to which the audio file being played belongs; and
generating, by the audio playing device, the audio file subscription request according to the identification.

46. The non-transitory computer readable medium of claim 45, wherein generating, by the audio playing device, the audio file subscription request according to the identification comprises:
generating, by the audio playing device, the audio file subscription request according to the identification, an address of the audio playing device, and a user identification.

47. The non-transitory computer readable medium of claim 45, wherein the audio file subscription instruction comprises at least one of the following:
an electrical signal generated when an indicator light on the audio playing device is pressed;
an electrical signal generated when a physical key on the audio playing device is pressed;
an electrical signal generated when a touch screen on the audio playing device is touched;
an electrical signal generated when a knob on the audio playing device is rotated;
a voice signal input into the audio playing device; and
a specified biometric characteristic input into the audio playing device.

48. The non-transitory computer readable medium of claim 40, wherein acquiring the updated audio file by the audio playing device in response to the audio file acquisition instruction comprises:
sending, by the audio playing device, an address acquisition request to an audio subscription server;
receiving, by the audio playing device, an acquisition address of the updated audio file, the acquisition address being sent by the audio subscription server;
sending, by the audio playing device, an audio file acquisition request to an audio content source according to the acquisition address; and
receiving, by the audio playing device, the updated audio file sent by the audio content source according to the audio file acquisition request.

49. The non-transitory computer readable medium of claim 48, wherein the address acquisition request comprises at least one of the following:
an identification of an audio file series to which a locally stored subscribed audio file belongs;
an identification of an audio file series acquired from the audio file update notification; and
a user identification.

50. The non-transitory computer readable medium of claim 40, wherein acquiring the updated audio file by the audio playing device in response to the audio file acquisition instruction comprises:
sending, by the audio playing device, an audio file acquisition request to an audio content source according to an acquisition address of the updated file, the acquisition address being obtained from the audio file update notification; and
receiving, by the audio playing device, the updated audio file sent by the audio content source according to the audio file acquisition request.

51. A non-transitory computer readable medium that stores a set of instructions, which are executable by at least one processor of an update notification sending device to perform an update notification sending method, the method comprising:
determining whether there is an updated audio file in an audio file series provided by an audio content source; and
sending an audio file update notification to an audio playing device, in response to a determination that there is an updated audio file.

52. The non-transitory computer readable medium of claim 51, wherein the audio file series is a subscribed audio file series, and wherein the determining, by the audio subscription server, whether there is an updated audio file in an audio file series provided by an audio content source comprises:
querying information of updated audio files from the audio content source, by the audio subscription server according to information of the subscribed audio file series; and
determining whether an updated audio file includes information matching the information of the subscribed audio file series.

53. The non-transitory computer readable medium of claim 51, wherein after sending, by the audio subscription server, the audio file update notification to the audio playing device, the method further comprises:
receiving, by the audio subscription server, an address acquisition request sent by the audio playing device;
acquiring, by the audio subscription server, an acquisition address of the updated audio file in response to the address acquisition request; and
sending, by the audio subscription server, the address of the updated audio file to the audio playing device.

54. The non-transitory computer readable medium of claim 51, wherein sending, by the audio subscription server, the audio file update notification to the audio playing device comprises:
acquiring, by the audio subscription server, an acquisition address of the updated audio file in response to the determination that the updated audio file in an audio file series is provided by the audio content source; and
sending the audio file update notification including the acquisition address to the audio playing device.

55. The non-transitory computer readable medium of claim 51, wherein the update notification sending method further comprises:
obtaining, by the audio subscription server from the audio content source, information of audio file series available for subscription;
sending, to the audio playing device, the information of the audio file series available for subscription;
receiving information selected by the audio playing device from the information of the audio file series available for subscription; and
storing the selected information as information of subscribed audio file series.

56. The non-transitory computer readable medium of claim 51, wherein the audio playing device comprises: a speaker.
